(19) United States
(12) Patent Application Publication
(10) Pub. No.: US 2023/0056248 A1
(43) Pub. Date: Feb. 23, 2023

(54) SAMPLE COLLECTION ASSEMBLY FOR A VEHICLE

(71) Applicant: Lunar Outpost Inc., Golden, CO (US)

(72) Inventors: Andrew Josef Gemer, Lafayette, CO (US); Justin Cyrus, Golden, CO (US); Van Wagner, Lakewood, CO (US); Peter Wilson, Lakewood, CO (US)

(21) Appl. No.: 17/821,781

(22) Filed: Aug. 23, 2022

Related U.S. Application Data
(60) Provisional application No. 63/235,944, filed on Aug. 23, 2021.

(51) Int. Cl. B60B 19/00; G01N 1/08

(52) U.S. Cl. CPC B60B 19/00; G01N 1/08; B60B 2900/351

(57) ABSTRACT

Aspects of the present disclosure relate to a sample collection assembly for a vehicle. The sample collection assembly includes a perforated ground-engaging member of the vehicle and an associated sample collector. For example, a perforated wheel may collect material from terrain under the vehicle as the wheel rotates (e.g., as may result from movement of the vehicle), which may fall through the perforation and into a sample collector disposed thereunder. In some examples, a ground-engaging member may include one or more grousers, paddles, or scoops, among other terrain interaction features, to further increase the amount of material that is collected. Such terrain interaction features may be unidirectional or bidirectional, thereby offering improved sample collection in one or both directions of operation, respectively. In examples, an image capture device or one or more other sensors may be used to monitor sample collection and/or to process data associated therewith.

### CROSS-REFERENCE TO RELATED APPLICATION

This application claims priority to U.S. Provisional Application No. 63/235,944, titled “Planetary Regolith Collection Wheel and Hopper Mechanism,” filed on Aug. 23, 2021, the entire disclosure of which is hereby incorporated by reference in its entirety.

### BACKGROUND

Sample collection typically involves additional, specialized hardware, which may result in added complexity, more points of failure, additional weight, and/or increased cost, among other detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a sample collection assembly for a vehicle. The sample collection assembly includes a perforated ground-engaging member of the vehicle and an associated sample collector. For example, a perforated wheel may collect material from terrain under the vehicle as the wheel rotates (e.g., as may result from movement of the vehicle), which may fall through the perforation and into a sample collector disposed thereunder. In some examples, a ground-engaging member may include one or more grousers, paddles, or scoops, among other terrain interaction features, to further increase the amount of material that is collected. Such terrain interaction features may be unidirectional or bidirectional, thereby offering improved sample collection in one or both directions of operation, respectively. In examples, an image capture device or one or more other sensors may be used to monitor sample collection and/or to process data associated therewith.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a conceptual diagram of an example vehicle with which a sample collection assembly may be used according to aspects described herein.

FIGS. 2A and 2B illustrate example sample collection assemblies.

FIG. 3A illustrates a front perspective view of an example sample collector that may be used as part of a sample collection assembly according to aspects described herein.

FIG. 3B illustrates a rear perspective view of the example sample collector of FIG. 3A.

FIG. 4A illustrates an exploded view of another example sample collector that may be used as part of a sample collection assembly according to aspects described herein.

FIG. 4B illustrates a front view of a sample collector body for the example sample collector of FIG. 4A.

FIG. 4C illustrates a rear view of a sample collector side for the example sample collector of FIG. 4A.

FIG. 5A illustrates a front perspective view of an example ground-engaging member that may be used as part of a sample collection assembly according to aspects described herein.

FIG. 5B illustrates a rear perspective view of the example ground-engaging member of FIG. 5A.

FIG. 5C illustrates a side view of the example ground-engaging member of FIG. 5A.

FIG. 5D illustrates a front perspective view of another example ground-engaging member, similar to the ground-engaging member illustrated by FIGS. 5A-5C.

FIG. 6A illustrates a front perspective view of another example ground-engaging member that may be used as part of a sample collection assembly according to aspects described herein.

FIG. 6B illustrates a rear perspective view of the example ground-engaging member of FIG. 6A.

FIG. 6C illustrates a side view of the example ground-engaging member of FIG. 6A.

FIG. 6D illustrates a rear perspective view of another example ground-engaging member, similar to the ground-engaging member illustrated by FIGS. 6A-6C.

FIG. 6E illustrates a side view of the example ground-engaging member of FIG. 6D.

FIG. 7 illustrates a front perspective view of another example ground-engaging member that may be used as part of a sample collection assembly according to aspects described herein.

FIG. 8 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, samples may be collected by a vehicle for further analysis. For example, a sample of dirt, dust, soil, rocks, regolith, and/or any of a variety of other materials may be collected on Earth, Mars, or the Moon, among other examples. However, sample collection is typically performed using specialized hardware, which may be included for the main or sole purpose of sample collection. Accordingly, the decision to perform sample collection may be tied to weight constraints, project timeline constraints, monetary constraints, and/or size constraints for the vehicle with which sample collection would be performed. Additionally, use of such specialized hardware may introduce additional points of failure and complicate control schemes for the systems of the vehicle, among other detriments.

Accordingly, aspects of the present application relate to a sample collection assembly for a vehicle, where the sample collection assembly includes a perforated ground-engaging member of the vehicle and an associated sample collector. For example, a perforated wheel may collect material from the terrain under the vehicle as the wheel rotates (e.g., as may result from movement of the vehicle), which may fall through the perforation and into a sample collector disposed thereunder. In examples, the wheel includes one or more grousers, paddles, or scoops, among other terrain interaction features, to further increase the amount of material that is collected. In examples, such terrain interaction features may be unidirectional or bidirectional, thereby offering improved sample collection in one or both directions of operation, respectively.

As used herein, a perforated ground-engaging member may include one or more holes, slots, or other openings through which material may pass. For example, the perforations may be formed in the wheel itself and/or may be formed in a mesh or other layer that is mechanically coupled to or integrated within the ground-engaging member, among other examples. The perforations may be sized and shaped to gather a sample having a particular set of characteristics, such that particles having a size and/or shape smaller than that of the perforations may pass through the ground-engaging member and into the sample collector accordingly.

Similarly, the sample collector may be sized and shaped to collect a sample of a predetermined volume or weight, among other examples. As an example, the sample collector may have a specific volume, such that, for a target sample having a known or expected density, the sample collector thus retains a sample of a predefined weight. The sample collector may be opaque or at least partially transparent. For example, the sample collector may be at least partially transparent to enable visual evaluation of the sample collection process and/or the sample itself (e.g., using an image capture device, as may be supported by or affixed to the vehicle). In some examples, the sample collector may be insulated so as to better maintain the temperature of the sample. As discussed in greater detail below, the sample collector may be coupled to an axle of the vehicle, coupled to the vehicle body itself, or integrated into a ground-engaging member, among other examples. Additionally, the sample collector may be removably attached in some examples, thereby offering easier sample processing after the sample has been collected by the vehicle.

Given the disclosed sample collection assembly comprises a ground-engaging member of the vehicle, aspects described herein may enable the use of pre-existing vehicle systems for sample collection (e.g., existing vehicle movement and/or power systems). As such, the described aspects may reduce the amount of specialized components and the resulting complexity that would otherwise be associated with sample collection by the vehicle.

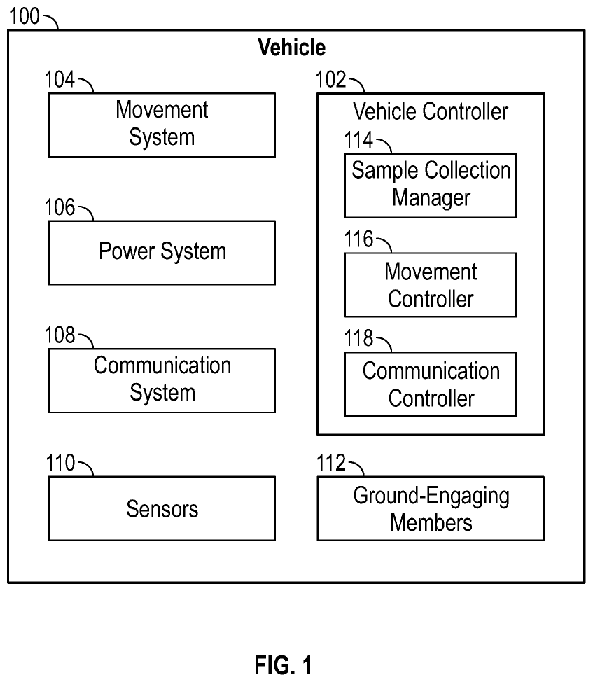

FIG. 1 illustrates a conceptual diagram of an example vehicle 100 with which a sample collection assembly may be used according to aspects described herein. As illustrated, vehicle 100 includes vehicle controller 102, movement system 104, power system 106, communication system 108, sensors 110, and ground-engaging members 112.

It will be appreciated that vehicle 100 may be any of a variety of vehicles, including, but not limited to, a rover, a robot, or a mining, survey, excavation, construction, and/or exploration vehicle, among other examples. In examples, vehicle 100 may be remotely controlled (e.g., via communication system 108) and/or may be autonomously controlled.

Movement system 104 may include a prime mover (e.g., an electric motor or an internal combustion engine) to power ground-engaging members 112, as well as a steering system, which may control a steering angle of one or more ground-engaging members 112 and/or may cause ground-engaging members 112 to be powered differently to achieve rotation about an axis. In examples, movement controller 116 of vehicle controller 102 controls movement system 104 to affect movement of vehicle 100 accordingly. For example, movement controller 116 may cause movement system 104 to propel vehicle 100 forward, backward, or in any of a variety of other directions. Movement controller 116 may control movement system 104 according to one or more commands that are received by vehicle 100 (e.g., via communication system 108) from a remote device (not pictured) and/or may control movement system 104 at least partially automatically (e.g., based on data from sensors 110).

Power system 106 may provide electrical power to movement system 104, communication system 108, and/or vehicle controller 102, among other examples. In examples, power system 106 includes a battery and a solar panel with which to recharge the battery. As another example, power system 106 may include a radioisotope thermoelectric generator. Thus, it will be appreciated that vehicle 100 may include any of a variety of power sources and, similarly, any of a variety of movement systems may be used to propel vehicle 100 accordingly.

Communication system 108 may include any of a variety of communication technologies to provide wired and/or wireless communication for vehicle 100. Communication controller 118 of vehicle controller 102 may control communication system 108, thereby enabling communication to and/or from vehicle 100. For example, communication controller 118 may configure one or more radios of communication system 108 and/or may establish a connection with one or more remote devices.

Vehicle controller 102 is illustrated as further comprising sample collection manager 114. Sample collection manager 114 may control movement controller 116 and/or communication controller 118 to facilitate sample collection according to aspects described herein. For example, vehicle 100 may receive one or more commands via communication system 108, which may be processed by vehicle controller 102 to control movement, and thus sample collection, of vehicle 100. For instance, sample collection manager 114 may cause vehicle 100 to move in a direction associated with sample collection (e.g., as may be the case when one or more ground-engaging members 112 includes unidirectional terrain interaction features). As another example, sample collection manager 114 may provide information associated with sample collection via communication system 108, such as an image of a sample collector (e.g., as may be obtained using an image capture device of sensors 110) and/or a sample collection status (e.g., as may be determined using one or more sensors 110), among other examples.

Sensors 110 of vehicle 100 may include any of a variety of sensors, including, but not limited to, image capture devices (e.g., visible light and/or infrared cameras), light sensors, proximity sensors, temperature sensors, and/or chemical composition sensors, among other examples. For instance, an image capture device may be positioned to observe a sample collector and/or the sample collection process. As another example, a sample collector may include or may otherwise be coupled to one or more sensors, such as a weight sensor, an electrical resistance sensor, and/or a temperature sensor, thereby enabling sensing of a collected sample. For example, a sensor may be disposed within a cavity of the sample collector.

Thus, sample collection manager 114 may process data from one or more sensors 110 associated with a sample collector to generate a sample collection status. The sample collection status may include a sample weight, a sample temperature, a sample water content (e.g., as may be determined based on a detected electrical resistance), and/or a sample density (e.g., as may be determined based on a detected weight and a volume of the sample collector, which may be known or may be detected using associated image data), among other information. In examples, the sample collection status comprises an indication as to how full the sample collector is (e.g., as may be determined based on a detected weight versus an expected weight or as may be determined visually). While example sensors and associated processing are discussed, it will be appreciated that any of a variety of other sensors and associated data processing may be used in other examples.

As illustrated vehicle 100 includes one or more ground-engaging members 112. Example ground-engaging members include, but are not limited to, wheels, tracks, skids, casters, legs, or robotic arms, among other examples. At least one ground-engaging member of vehicle 100 may operate as part of a sample collection assembly according to aspects described herein. For example, the ground engaging member may be perforated and may have one or more associated sample collectors with which to capture material as it passes through perforations of the ground-engaging member. In examples, vehicle 100 multiple ground-engaging members of vehicle 100 are used for sample collection. For example, each sample collection assembly may be configured to capture a similar sample (e.g., thereby offering redundancy) or may be configured to capture different samples (e.g., having different particle sizes and/or shapes). In some examples, ground-engaging members used for sample collection may be at opposing sides (e.g., left/right and/or front/back) of the vehicle, thereby substantially maintaining the balance of vehicle 100 even after the respective sample collectors are full.

It will be appreciated that vehicle 100 is provided as an example of a vehicle with which a sample collection assembly may be used according to aspects described herein. Any of a variety of other vehicles may be used in other examples. Additionally, while examples are described with respect to sample collection for terrain, aspects of the present disclosure need not be limited to land and may be used in any of a variety of other surfaces or contexts (e.g., on or near the surface of a body of water, in a subterranean context, or along the floor of a body of water).

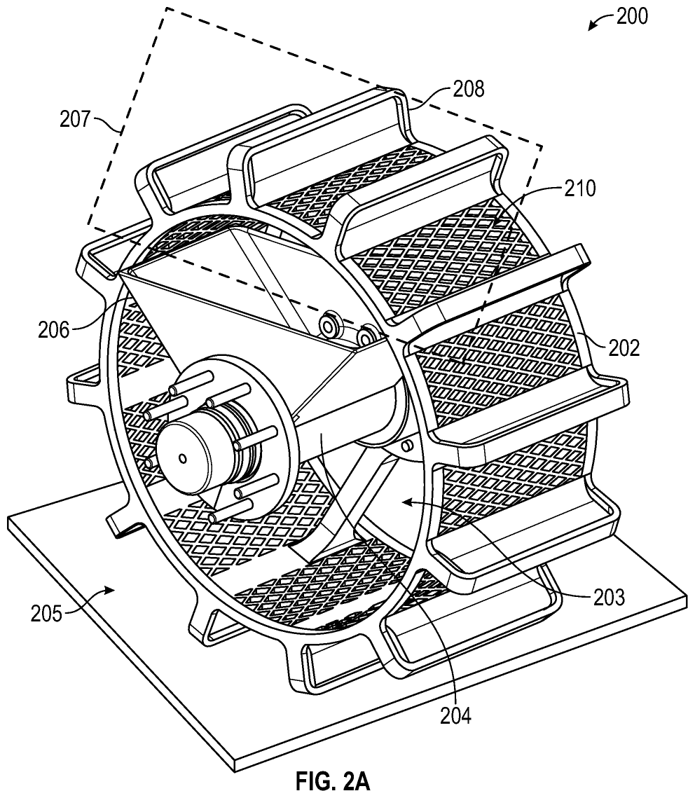

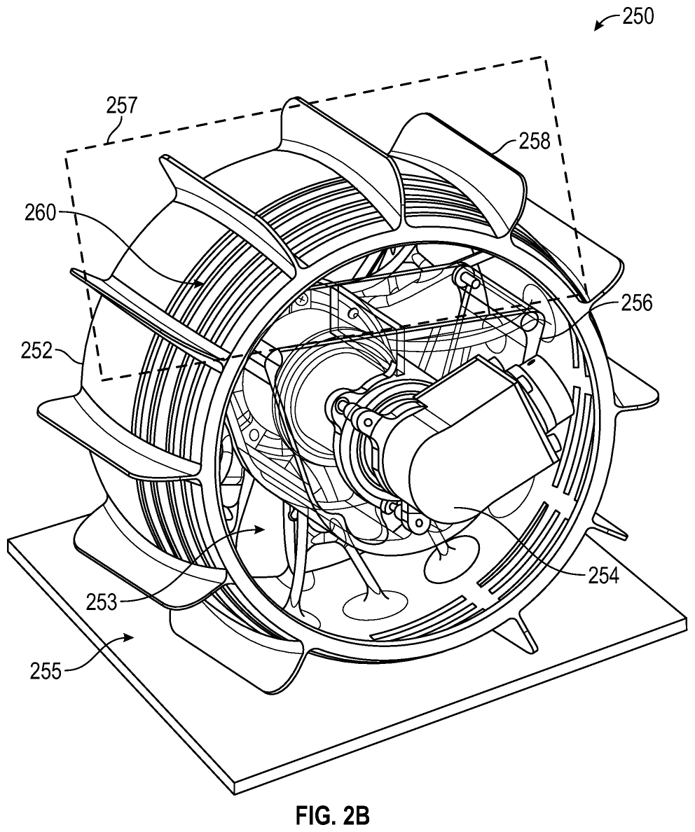

FIGS. 2A and 2B illustrate example sample collection assemblies 200 and 250 that may be used by a vehicle (e.g., vehicle 100) according to aspects described herein. With reference to FIG. 2A, sample collection assembly 200 includes ground-engaging member 202 and sample collector 206. Sample collector 206 is disposed within inner region 203 and supported by axle 204, which may be mechanically coupled to a vehicle (e.g., vehicle 100), such that it may be driven by a movement system of the vehicle accordingly (e.g., movement system 104).

As illustrated, ground-engaging member 202 is a wheel, but it will be appreciated that any of a variety of other ground-engaging members may be used in other examples. Ground-engaging member 202 further includes terrain interaction features 208, which may facilitate sample collection from the underlying terrain as ground-engaging member 202 traverses the terrain. As ground-engaging member 202 rotates, part of the terrain traversed by the wheel may adhere to or otherwise be collected by a portion of ground-engaging member 202 that contacts surface 205 (e.g., the bottom of ground-engaging member 202 and/or at least a part of terrain interaction features 208). Accordingly, at least a part of the material may fall through perforations 210 as it arrives at or near top region 207 of ground-engaging member 202 relative to surface 205 being traversed by the vehicle (e.g., as a result of gravity), where it may ultimately be deposited into sample collector 206. As illustrated, perforations 210 include a mesh that is formed in wheel 200. The mesh may be sized and shaped to sample grains having a specific size and/or shape according to aspects described herein.

Turning now to FIG. 2B, sample collection assembly 250 includes ground-engaging member 252, axle 254, sample collector 256 (which is disposed within inner region 253 and collects material that reaches top region 257), and terrain interaction features 258 (which interact with surface 255). Aspects of ground-engaging member 252, axle 254, sample collector 256, terrain interaction features 258, inner region 253, surface 255, and top region 257 may be similar to elements 202, 204, 206, 208, 203, 205, and 207, respectively, and are therefore not necessarily redescribed below in detail.

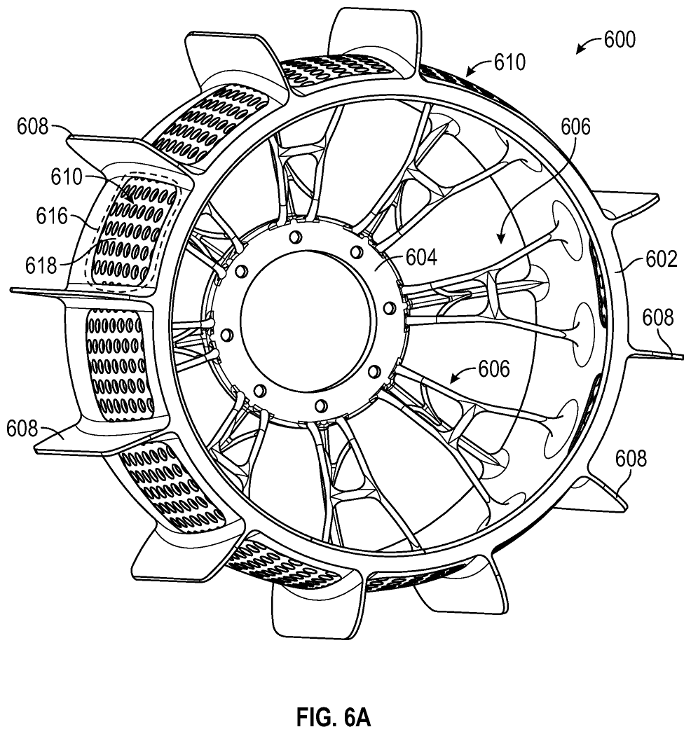

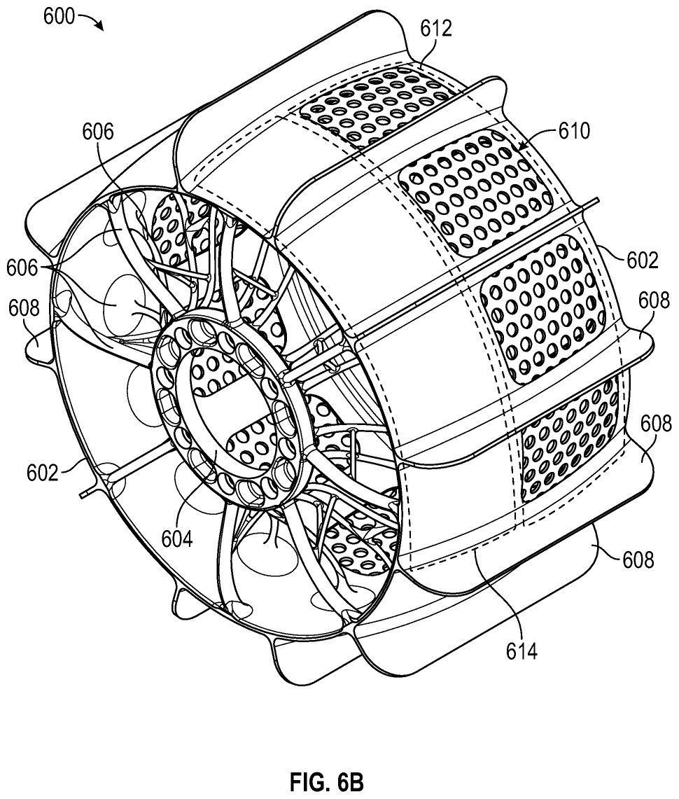

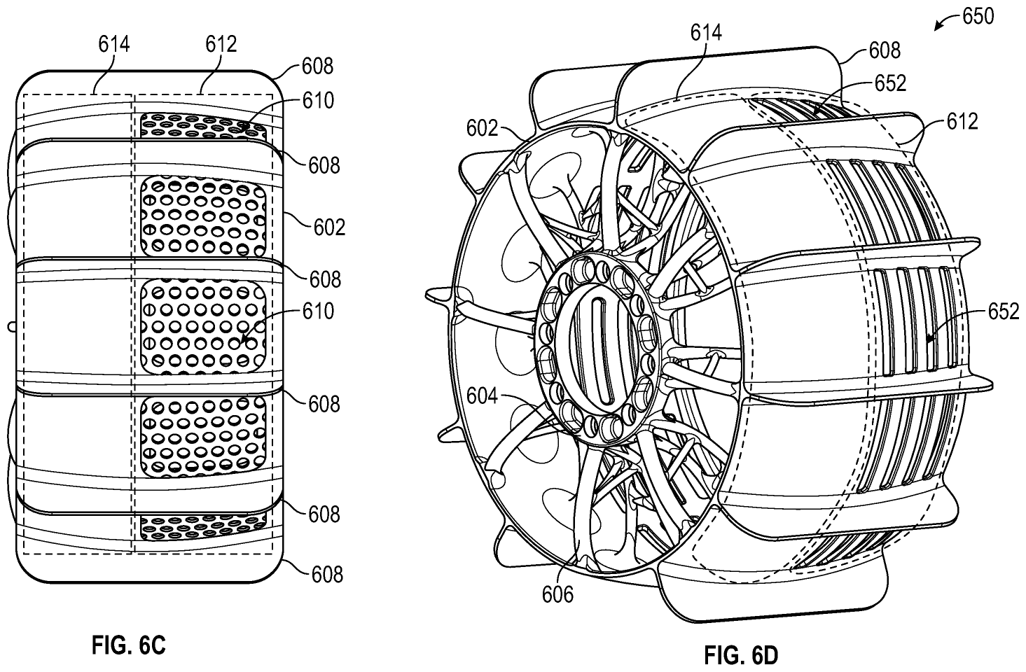

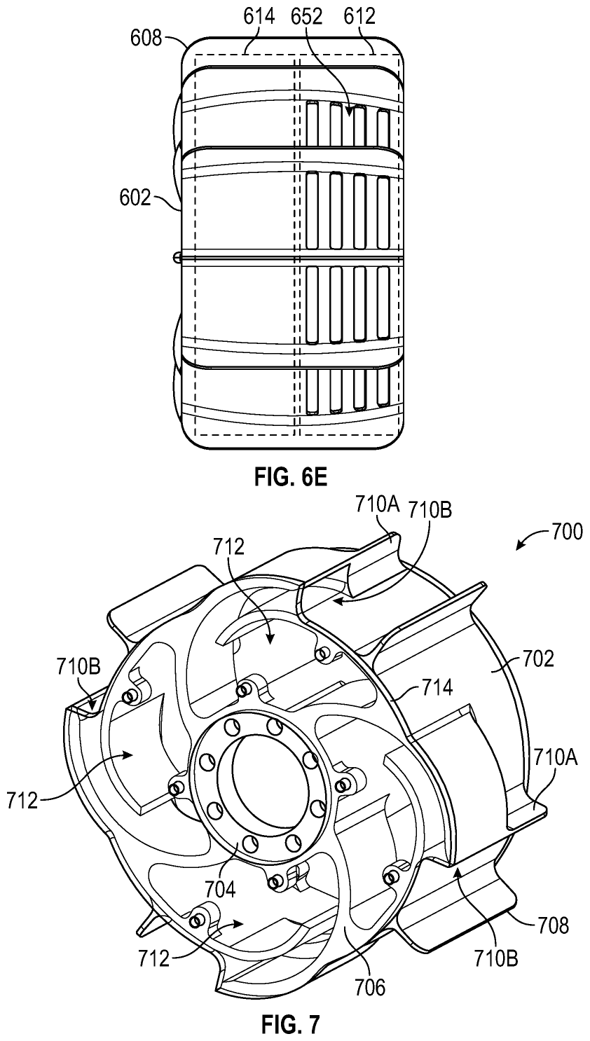

As illustrated, ground-engaging member 252 includes perforations 260, which span a first axial region, while a second axial region of ground-engaging member 252 does not include such perforations. In examples, only a subpart of the outer surface of a ground-engaging member may be perforated, so as to reduce the likelihood that material is deposited outside of sample collector 256 (e.g., on other elements of the sample collection assembly and/or the vehicle). Additional examples of such aspects are discussed below with respect to FIGS. 6A-6E.

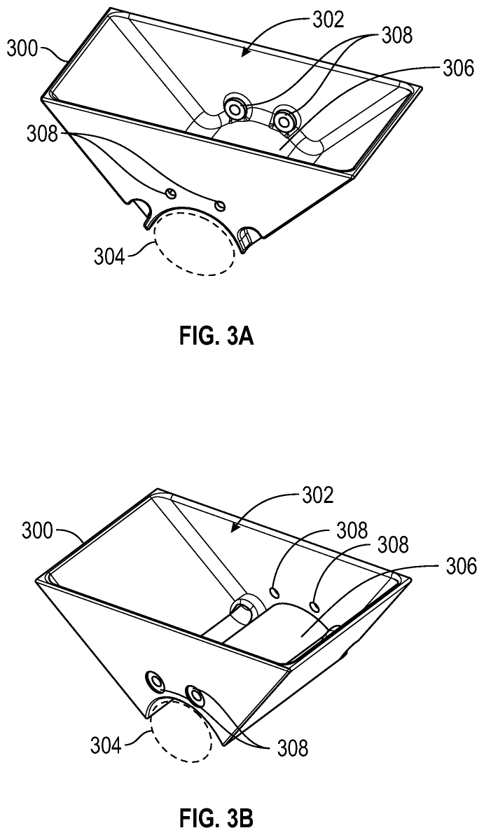

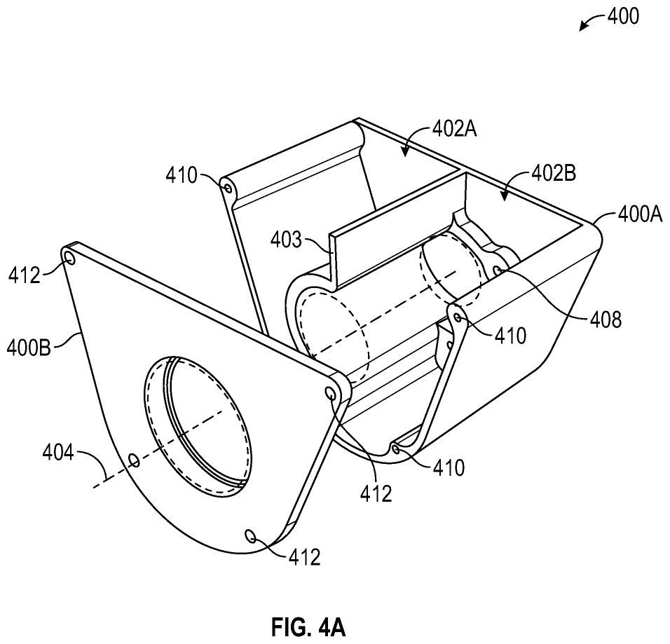

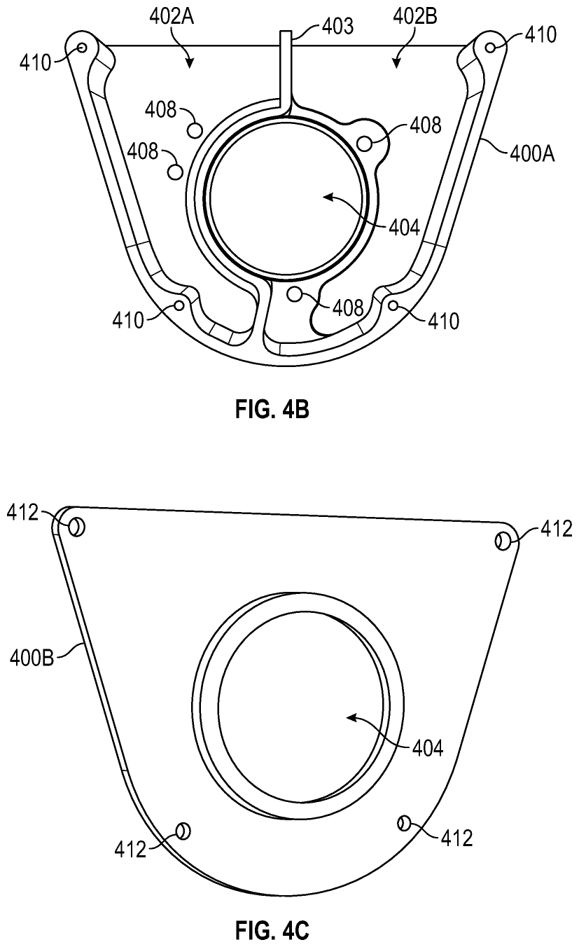

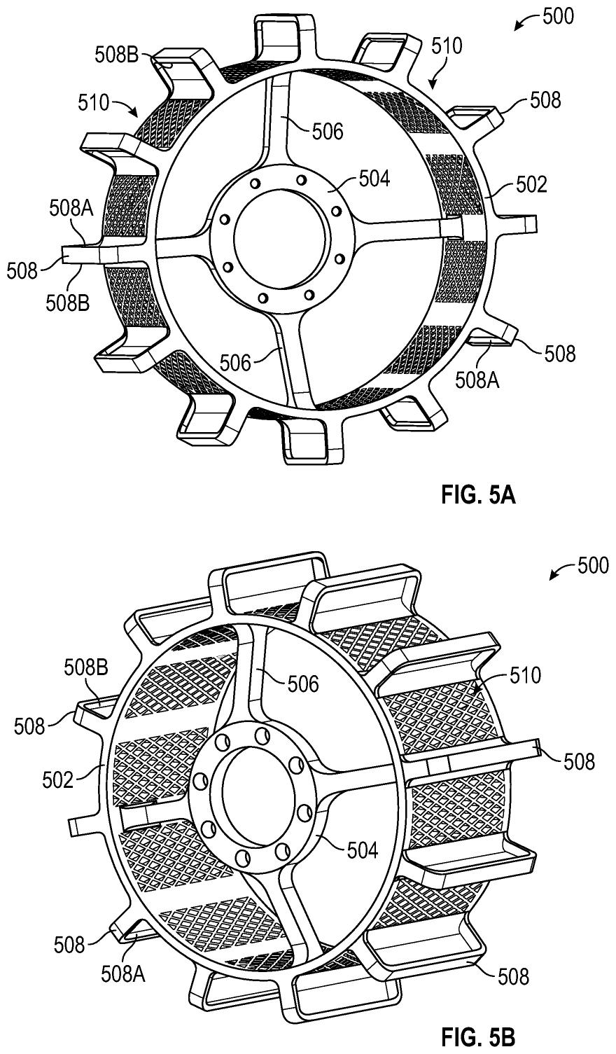

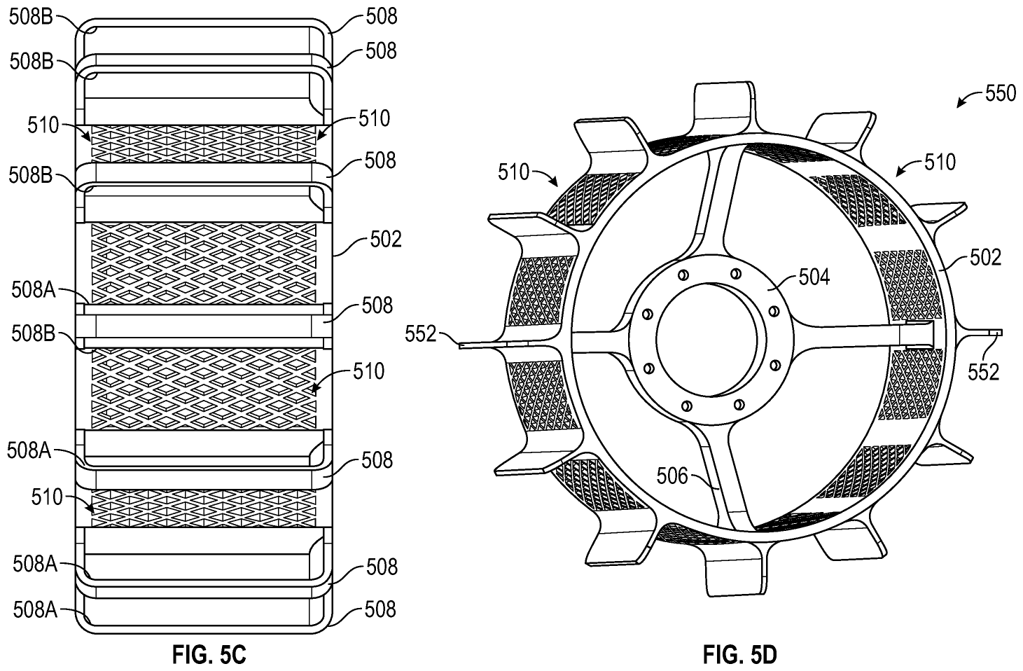

Sample collection assemblies 200 and 250 of FIGS. 2A and 2B are provided to illustrate example ground-engaging members 202, 252 and associated sample collectors 206, 256 that may be used to facilitate sample collection by a vehicle (e.g., vehicle 100) according to aspects described herein. While ground-engaging members 202 and 252 are each illustrated as comprising terrain interaction features 208 and 258, respectively, it will be appreciated that a ground-engaging member may omit such features in other examples. Additional aspects of example sample collectors are discussed below with respect to FIGS. 3A-3B and 4A-4C, while additional aspects of example ground-engaging members are discussed below with respect to FIGS. 5A-5D, 6A-6E, and 7.

FIGS. 3A and 3B illustrate an example sample collector 300 that may be used as part of a sample collection assembly according to aspects described herein. As illustrated, sample collector 300 is wedge- or funnel-shaped. Sample collector 300 includes cavity 302, which may be positioned within a ground-engaging member (e.g., beneath a top portion of the ground-engaging member) to permit material to enter into sample collector 300, thus forming a sample collection assembly (e.g., as was discussed above with respect to FIGS. 2A and 2B) according to aspects described herein. As illustrated, sample collector 300 includes protrusion 306 that extends into cavity 302, which may rest on top of an axle or otherwise permit an axle of a vehicle (not pictured) to pass along the bottom of sample collector 300 accordingly.

Sample collector 300 further includes mounting holes 308, which may be used to fasten sample collector assembly to a vehicle or an axle, among other examples. For instance, FIG. 2A illustrates an example where sample collector 206 (aspects of which are similar to sample collector 300) is fastened to axle 204 accordingly. It will be appreciated that any of a variety of additional or alternative coupling techniques may be used in other examples, including, but not limited to, one or more magnets, retention rods/pins, and/or clasps. As another example, a sample collector may instead be formed as part of an element of the vehicle, among other examples.

FIGS. 4A-4C illustrate another example sample collector 400 that may be used as part of a sample collection assembly according to aspects described herein. As illustrated, sample collector 400 includes collector body 400A and collector side 400B. Thus, as compared to sample collector 300, sample collector 400 comprises multiple parts, which may improve sample extraction (e.g., after the sample has been collected) in some examples. Sample collector 400 may be assembled using fasteners, which may pass through holes 412 and into holes 410, thereby securing collector body 400A and collector side 400B. It will be appreciated that any of a variety of fasteners and/or assembly techniques may be used in other examples.

Additionally, sample collector 400 is configured to receive an axle through region 404. Thus, sample collector 400 is provided as an example in which an axle of a vehicle may pass through the sample collector, rather than beneath the sample collector as was illustrated in FIGS. 3A-3B. It will therefore be appreciated that a sample collector may occupy any volume within a ground-engaging member and/or may be positioned at any of a variety of regions therein. Similar to sample collector 300, sample collector 400 may be mechanically coupled to a vehicle using holes 408, each of which may receive a fastener therethrough.

Sample collector 400 further includes divider 403, which forms first cavity 402A and second cavity 402B. Thus, as compared to sample collector 300, sample collector 400 may capture multiple samples. In examples, a mesh may be positioned above one or both of cavities 402A-B, such that the respective samples that are collected within cavities 402A-B each have different associated characteristics. As another example, divider 403 may be configured to collect samples having a different associated volume. As noted above, sample collector 400 may be at least partially transparent, such that the content of cavities 402A-B may be visible (e.g., to an image capture device).

It will be appreciated that the aspects discussed above with respect to sample collectors 300 and 400 are provided as examples and, in other examples, a sample collector may have a variety of different features. As an example, a sample collector may have a bottom that is perforated, thereby enabling the collection of a sample having an upper limit grain size (e.g., as may be defined by perforations of a ground-engaging member and/or a mesh above the sample collector) and a lower limit grain size (e.g., as may be defined by the perforated bottom).

FIGS. 5A-5C illustrate an example ground-engaging member 500 that may be used as part of a sample collection assembly (e.g., sample collection assembly 200 or 250 discussed above with respect to FIGS. 2A-2B) according to aspects described herein. As illustrated, ground-engaging member 500 includes hub 504, which is coupled to outer surface 502 by spokes 506. While four spokes 506 are illustrated, it will be appreciated that any number of spokes may be used. Hub 504 may be coupled to a vehicle (e.g., vehicle 100 discussed above with respect to FIG. 1), an example of which is illustrated in FIG. 2A.

Outer surface 502 includes perforations 510 and terrain interaction features 508, aspects of which may be similar to those perforations 210, 260 and terrain interaction features 208, 258 discussed above with respect to FIGS. 2A-2B and are therefore not necessarily redescribed below in detail. As illustrated, terrain interaction features 508 include a first edge 508A and a second edge 508B. Thus, terrain interaction features 508 may offer bidirectional interaction with the terrain as ground-engaging member 500 traverses the terrain accordingly. Edges 508A, 508B may pick up or otherwise disrupt terrain beneath ground-engaging member 500 to improve material collection, such that at least some of the material is carried toward the top of ground-engaging member 500, at which point it may fall through perforations 510 and into a sample collector according to aspects described herein.

In some examples, one or both edges 508A, 508B may be omitted. For example, if one set of edges is omitted, the ground-engaging member may instead exhibit unidirectional terrain interaction, such that material collection may be improved in a first direction of operation as compared to a second direction. FIG. 5D illustrates another example ground-engaging member 550, which is similar to ground-engaging member 500 illustrated in FIGS. 5A-5C but terrain interaction features 552 omit both edges 508A, 508B. Thus, in addition to ground-engaging members that may omit such terrain interaction features altogether, it will be appreciated that terrain interaction features may include or omit various edges, dimples, or other geometry that improves or reduces material collection in one or more directions of operation.

FIGS. 6A-6C illustrate another example ground-engaging member 600 that may be used as part of a sample collection assembly according to aspects described herein. Aspects of ground-engaging member 600 may be similar to other ground-engaging members discussed above with respect to FIGS. 1, 2A-2B, and 5A-5D and are therefore not necessarily redescribed in detail below. For example, ground-engaging member 600 includes outer surface 602, hub 604, terrain interaction features 608, and perforations 610, aspects of which may be similar to surface 502, hub 504, terrain interaction features 508, 552, and perforations 510 as discussed above with respect to FIGS. 5A-5D.

As compared to ground-engaging member 500, ground-engaging member 600 includes spokes 606, which were generated according to topology optimization techniques, thereby reducing the amount of material that is used to provide a given amount of strength (e.g., according to a weight of an associated vehicle). Thus, it will be appreciated that any of a variety of configurations may be used for ultimately coupling the outer surface of a wheel to an axle vehicle.

With specific reference to FIG. 6A, perforations 610 of ground-engaging member 600 are formed in mesh layer 618, rather than within outer surface 602 itself. Thus, region 616 of outer surface 602 may be open so as to permit mesh 618 to filter material according to aspects described herein. In examples, mesh layer 618 may span the circumference of ground-engaging member 600 or, as another example, each region 616 may have an associated piece of mesh 618. Mesh 618 may be adhered, welded, or otherwise mechanically coupled to the interior of ground-engaging member 600 (e.g., opposite outer surface 602). As another example, mesh 618 may be incorporated into ground-engaging member 600 during manufacture, such that mesh layer 618 is integrated into ground-engaging member 600 accordingly.

Turning now to FIG. 6B, ground-engaging member 600 includes first axial region 612 and second axial region 614, where first axial region 612 includes perforations 610, while second axial region 614 does not. As noted above, axial regions 612, 614 may be positioned such that material passes through perforations 610 of axial region 612, while axial region 614 instead prevents material from passing through and collecting on one or more parts thereunder (e.g., hub 604). It will be appreciated that axial regions 612, 614 may be sized according to any of a variety of additional or alternative considerations, such as the speed with which a sample is to be collected. As another example, additional axial regions may be used, as may be the case when a sample collector has multiple sample collection cavities (e.g., cavities 402A and 402B in FIGS. 4A-4C). In such an example, each axial region that is used for sampling may have different associated perforations, thereby collecting samples having different associated characteristics.

Ground-engaging member 600 is further illustrated as including an outer surface 602 that includes cambered profile (as compared to the substantially straight profile of ground-engaging members 500, 550 in FIGS. 5A-5D). In examples, a cambered profile may be used to permit easier steering, turning, and/or skid-steering.

FIGS. 6D-6E illustrate another example ground-engaging member 650, aspects of which are similar to ground-engaging member 600 discussed above with respect to FIGS. 6A-6C. However, in contrast to ground-engaging member 600, ground-engaging member 650 includes perforations 652, which are slots through outer surface 602. As compared to perforations 610, (e.g., where mesh 618 disposed in regions 616), perforations 652 are formed as part of outer surface 602. As an example, forming slots in outer surface 602 may be an easier geometry to manufacture as compared to a mesh, such that a separate perforation layer need not be used. It will be appreciated that, depending on the manufacturing technology (e.g., relating to the minimum feature size associated therewith), various perforation geometries may be possible without the use of a separate perforation layer. Further, while example perforation types, patterns, and associated geometries are illustrated and described, it will be appreciated that any of a variety of other geometries may be used in other examples.

FIG. 7 illustrates another example ground-engaging member 700 that may be used as part of a sample collection assembly according to aspects described herein. Aspects of ground-engaging member 700 may be similar to other ground-engaging members discussed above with respect to FIGS. 1, 2A-2B, 5A-5D, and 6A-6E and are therefore not necessarily redescribed in detail below. As illustrated, ground-engaging member 700 includes outer surface 702, hub 704, spokes 706, and terrain interaction features 708.

In addition to terrain interaction features 708, ground-engaging member 700 further includes perforated terrain interaction features 710A, each of which include channel 710B. Channel 710B may direct material (e.g., that is collected by terrain interaction features 708, 710A and/or that gathers on outer surface 702) into a sample collector cavity 712. Thus, in some examples, a sample collector may be incorporated into the ground-engaging member itself.

In examples, hub 704, spokes 706, and/or outer surface 702 may form a single part, which may be covered by a side piece 714. A similar side piece (not pictured) may cover the opposite side of ground-engaging member 700 or, as another example, the back side may similarly be formed from the same part as the hub, spokes, and/or outer surface. Side piece 714 may be at least partially transparent, such that a sample collected therein is visible (e.g., to an image capture device). In an example, ground-engaging member 700 is unidirectional, such that material is sampled at a higher rate in one direction (e.g., as the ground-engaging member spins counterclockwise) than another direction (e.g., clockwise).

Various example ground-engaging members and sample collectors are discussed above with respect to FIGS. 2A-2B, 3A-3B, 4A-4C, 5A-5D, 6A-6E, and 7. It will be appreciated that the disclosed features are not exclusive to the examples in which they are described and may be combined in a variety of other ways to yield any of a variety of other ground-engaging members and/or sample collectors for a sample collection assembly according to aspects described herein.

For example, slotted perforations similar to ground-engaging member 650 of FIGS. 6D and 6E may be used in combination with a straight-profile outer surface ground-engaging member similar to ground-engaging member 500 of FIGS. 5A-5D. As another example, a mesh similar to ground-engaging member 500 (e.g., spanning substantially all of the axial area of the outer surface) may be used in combination with a cambered-profile ground-engaging member similar to that of ground-engaging member 600 in FIGS. 6A-6E. Finally, spokes similar to spokes 606 in FIGS. 6A-6E may be used for a ground-engaging member that is otherwise similar to ground-engaging members 500, 550, or 700 in FIGS. 5A-5C, 5D, and 7, respectively.

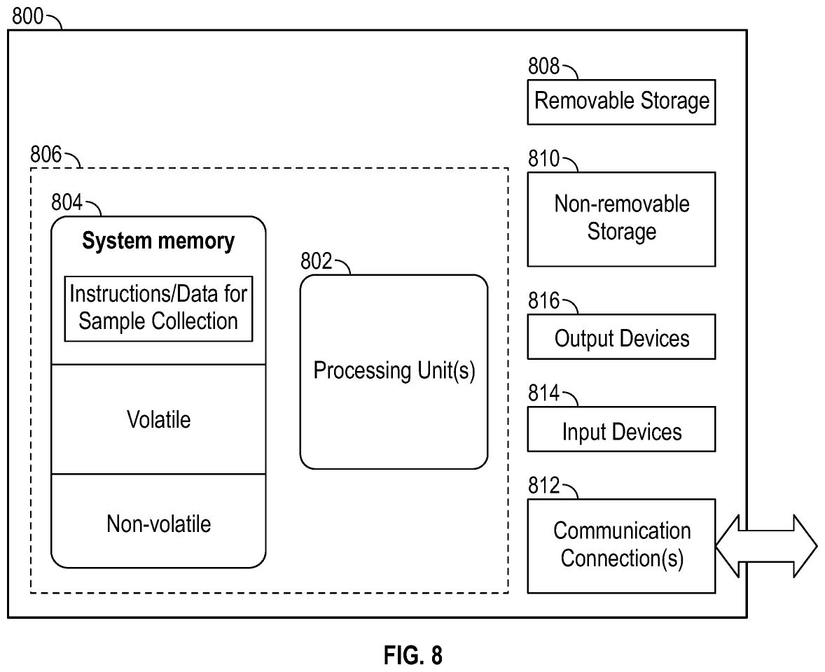

FIG. 8 illustrates an example of a suitable operating environment 800 in which one or more of the present embodiments may be implemented. For example, aspects of operating environment 800 may be used by a vehicle controller, such as vehicle controller 102 in FIG. 1. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 800 typically may include at least one processing unit 802 and memory 804. Depending on the exact configuration and type of computing device, memory 804 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 8 by dashed line 806. Further, environment 800 may also include storage devices (removable, 808, and/or non-removable, 810) including, but not limited to, magnetic or optical disks or tape. Similarly, environment 800 may also have input device(s) 814 such as a keyboard, mouse, pen, voice input, etc. and/or output device(s) 816 such as a display, speakers, printer, etc. Also included in the environment may be one or more communication connections, 812, such as LAN, WAN, point to point, etc.

Operating environment 800 may include at least some form of computer readable media. The computer readable media may be any available media that can be accessed by processing unit 802 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 800 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 804. While executing on the processing unit 802, program modules (e.g., applications, Input/Output (I/O) management, and other utilities) may perform processes including, but not limited to, one or more of the stages of the operational methods described herein.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 800 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The following clauses are provided as example aspects of the disclosed subject matter:

1. A sample collection assembly for a vehicle, comprising: a ground-engaging member having an outer surface and an inner region, wherein the outer surface of the ground-engaging member is perforated to allow material to pass therethrough; and a sample collector disposed within the inner region of the ground-engaging member and further positioned beneath a top region of the ground-engaging member relative to a surface traversed by the vehicle, such that material passing through the perforated outer surface of the ground-engaging member is collected within a cavity of the sample collector.

2. The sample collection assembly of clause 1, further comprising an axle that supports a hub of the ground-engaging member, wherein the sample collector is removably coupled to at least one of the axle or the hub.

3. The sample collection assembly of any one of clauses 1-2, wherein the ground-engaging member further comprises a terrain interaction feature.

4. The sample collection assembly of clause 3, wherein the terrain interaction feature comprises an edge for unidirectional terrain interaction.

5. The sample collection assembly of clause 3, wherein the terrain interaction feature comprises a first edge and a second edge for bidirectional terrain interaction.

6. The sample collection assembly of any one of clauses 1-5, wherein the ground engaging member further comprises one or more spokes that connect a hub to the perforated outer surface, wherein the spokes were generated according to topology optimization.

7. The sample collection assembly of any one of clauses 1-6, wherein the sample collector further comprises a sensor disposed within the cavity of the sample collector.

8. The sample collection assembly of any one of clauses 1-7, wherein: the ground engaging member comprises a first axial region and a second axial region; the sample collector is disposed beneath the first axial region; the first axial region is perforated; and the second axial region is not perforated.

9. The sample collection assembly of any one of clauses 1-8, wherein the perforated outer surface comprises one or more slots configured to permit material to pass therethrough.

10. The sample collection assembly of any one of clauses 1-9, wherein the perforated outer surface comprises a mesh configured to permit material to pass therethrough.

11. The sample collection assembly of any one of clauses 1-10, wherein the sample collector further comprises a perforated bottom.

12. The sample collection assembly of clause 11, wherein: the perforated outer surface is sized to permit a first grain size to pass through; the perforated bottom is sized to permit a second grain size to pass through; and the first grain size is larger than the second grain size.

13. The sample collection assembly of any one of clauses 1-12, wherein the ground-engaging member has one of a cambered profile or a straight profile.

14. A vehicle, comprising: a plurality of ground-engaging members; a power source supported by the plurality of ground-engaging members; a prime mover electrically coupled to the power source; and a sample collector disposed within an inner region of a ground-engaging member of the plurality of ground-engaging members, such that the ground-engaging member and the sample collector form a sample collection assembly.

15. The vehicle of clause 14, wherein: the sample collection assembly is a first sample collection assembly; the ground-engaging member and the sample collector of the first sample collection assembly is a first ground-engaging member and a first sample collector; and the vehicle further comprises a second sample collector disposed within an inner region of a second ground-engaging member of the plurality of ground-engaging members, such that the second sample collector and the second ground-engaging member form a second sample collection assembly.

16. The vehicle of clause 15, wherein the first sample collection assembly and the second sample collection assembly are located at opposing ends of the vehicle.

17. The vehicle of any one of clauses 15-16, wherein the first sample collection assembly is configured to capture material having a set of characteristics that is different from the second sample collection assembly.

18. The vehicle of any one of clauses 14-17, wherein the vehicle further comprises an image capture device supported by the plurality of ground-engaging members and the image capture device is positioned to observe at least a part of the sample collection assembly.

19. A sample collection assembly, comprising: a ground-engaging member comprising: a terrain interaction feature; and a perforated outer surface to allow material to pass therethrough; and a sample collector disposed beneath a top region of the ground-engaging member relative to a surface traversed by the ground-engaging member, such that material passing through the perforated outer surface at the top region of the ground-engaging member is collected within a cavity of the sample collector.

20. The sample collection assembly of clause 19, wherein: the ground engaging member comprises a first axial region and a second axial region; the sample collector is disposed beneath the first axial region; the first axial region is perforated; and the second axial region is not perforated.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A sample collection assembly for a vehicle, comprising:
a ground-engaging member having an outer surface and an inner region, wherein the outer surface of the ground-engaging member is perforated to allow material to pass therethrough; and
a sample collector disposed within the inner region of the ground-engaging member and further positioned beneath a top region of the ground-engaging member relative to a surface traversed by the vehicle, such that material passing through the perforated outer surface of the ground-engaging member is collected within a cavity of the sample collector.

2. The sample collection assembly of claim 1, further comprising an axle that supports a hub of the ground-engaging member, wherein the sample collector is removably coupled to at least one of the axle or the hub.

3. The sample collection assembly of claim 1, wherein the ground-engaging member further comprises a terrain interaction feature.

4. The sample collection assembly of claim 3, wherein the terrain interaction feature comprises an edge for unidirectional terrain interaction.

5. The sample collection assembly of claim 3, wherein the terrain interaction feature comprises a first edge and a second edge for bidirectional terrain interaction.

6. The sample collection assembly of claim 1, wherein the ground engaging member further comprises one or more spokes that connect a hub to the perforated outer surface, wherein the spokes were generated according to topology optimization.

7. The sample collection assembly of claim 1, wherein the sample collector further comprises a sensor disposed within the cavity of the sample collector.

8. The sample collection assembly of claim 1, wherein:
the ground engaging member comprises a first axial region and a second axial region;
the sample collector is disposed beneath the first axial region;
the first axial region is perforated; and
the second axial region is not perforated.

9. The sample collection assembly of claim 1, wherein the perforated outer surface comprises one or more slots configured to permit material to pass therethrough.

10. The sample collection assembly of claim 1, wherein the perforated outer surface comprises a mesh configured to permit material to pass therethrough.

11. The sample collection assembly of claim 1, wherein the sample collector further comprises a perforated bottom.

12. The sample collection assembly of claim 11, wherein:
the perforated outer surface is sized to permit a first grain size to pass through;
the perforated bottom is sized to permit a second grain size to pass through; and
the first grain size is larger than the second grain size.

13. The sample collection assembly of claim 1, wherein the ground-engaging member has one of a cambered profile or a straight profile.

14. A vehicle, comprising:
a plurality of ground-engaging members;
a power source supported by the plurality of ground-engaging members;
a prime mover electrically coupled to the power source; and
a sample collector disposed within an inner region of a ground-engaging member of the plurality of ground-engaging members, such that the ground-engaging member and the sample collector form a sample collection assembly.

15. The vehicle of claim 14, wherein:
the sample collection assembly is a first sample collection assembly;
the ground-engaging member and the sample collector of the first sample collection assembly is a first ground-engaging member and a first sample collector; and
the vehicle further comprises a second sample collector disposed within an inner region of a second ground-engaging member of the plurality of ground-engaging members, such that the second sample collector and the second ground-engaging member form a second sample collection assembly.

16. The vehicle of claim 15, wherein the first sample collection assembly and the second sample collection assembly are located at opposing ends of the vehicle.

17. The vehicle of claim 15, wherein the first sample collection assembly is configured to capture material having a set of characteristics that is different from the second sample collection assembly.

18. The vehicle of claim 14, wherein the vehicle further comprises an image capture device supported by the plurality of ground-engaging members and the image capture device is positioned to observe at least a part of the sample collection assembly.

19. A sample collection assembly, comprising:
a ground-engaging member comprising:
a terrain interaction feature; and
a perforated outer surface to allow material to pass therethrough; and
a sample collector disposed beneath a top region of the ground-engaging member relative to a surface traversed by the ground-engaging member, such that material passing through the perforated outer surface at the top region of the ground-engaging member is collected within a cavity of the sample collector.

20. The sample collection assembly of claim 19, wherein:
the ground engaging member comprises a first axial region and a second axial region;
the sample collector is disposed beneath the first axial region;
the first axial region is perforated; and
the second axial region is not perforated.
